(19) United States
(12) Patent Application Publication
(10) Pub. No.: US 2013/0232700 A1
(43) Pub. Date: Sep. 12, 2013

(54) WASHING METHOD

(71) Applicant: THE PROCTER & GAMBLE COMPANY, Cincinnati, OH (US)

(72) Inventors: Andrew John SMITH, Newcastle-upon-Tyne (GB); Graeme Duncan CRUICKSHANK, Newcastle-upon-Tyne (GB); Euan John MAGENNIS, Newcastle-upon-Tyne (GB)

(73) Assignee: The Procter & Gamble Company, Cincinnati, OH (US)

(21) Appl. No.: 13/771,599

(22) Filed: Feb. 20, 2013

(30) Foreign Application Priority Data
Mar. 8, 2012 (EP) 12158685.3

(51) Int. Cl. C11D 11/00

(52) U.S. Cl. CPC C11D 11/0017
USPC 8/137

(57) ABSTRACT

A method of laundering fabric in a laundry machine, comprising the steps of:
a) placing the fabric into a laundry machine and adding a detergent composition;
b) subjecting the fabric to a two-parts washing cycle having a first and a second consecutive sub-cycles, the first sub-cycle having a first washing liquor and the second sub-cycle having a second washing liquor wherein the first washing liquor is more concentrated than the second washing liquor and preferably wherein the duration of the first washing sub-cycle is longer than the duration of the second washing sub-cycle; and
c) rinsing the fabric.

### FIELD OF THE INVENTION

The present invention is in the field of laundry. It relates to a method of laundering fabric in a laundry machine, in particular it relates to a method comprising a washing cycle and a rinsing cycle, wherein the washing cycle is divided into two sub-cycles having different detergent concentration and preferably different duration. The method provides outstanding cleaning and fabric maintenance. It is energy efficient in terms of time, heat and water usage.

### BACKGROUND OF THE INVENTION

Laundering is a very complex art. When designing a laundering method the designer attempts to achieve good cleaning, fabric maintenance and at the same time improve the energy efficiency of the process.

The object of the present invention is to provide an improved method of laundering fabric in terms of cleaning, fabric maintenance and energy efficiency.

### SUMMARY OF THE INVENTION

The present invention provides a method of laundering fabric in a laundry machine.

The method comprises the steps of:
a) placing the fabric into a laundry machine and adding a detergent composition;
b) subjecting the fabric to a two-parts washing cycle having a first and a second consecutive sub-cycles, the first sub-cycle having a first washing liquor and the second sub-cycle having a second washing liquor wherein the first washing liquor is more concentrated (i.e. higher detergent concentration) than the second washing liquor and preferably wherein the duration of the first washing sub-cycle is longer than the duration of the second washing sub-cycle; and
c) rinsing the fabric.

The laundry machine can be of any type, automatic, semi-automatic, etc.

Preferably the method of the invention is performed in an automatic washing machine. The automatic washing machine can be a top loader or a front loader. Preferred for use herein is a top loader washing machine.

The detergent composition can be any detergent composition, in any physical form. Preferred for use herein are detergent compositions comprising catalytic ingredients. By “catalytic” ingredients is meant herein ingredients which constitute less than about 5%, preferably less than about 4% and especially less than about 1% by weight of the composition. Catalytic ingredients require a low level and provide a great deal of cleaning. Preferred catalytic ingredients for use herein are enzymes.

The first step of the method of the invention is to place the fabric into a laundry machine and to add a detergent composition. In the case of a top loader machine the detergent can be added in the drum. In the case of a front loader machine the detergent can be added through the drawer.

The second step of the method of the invention is to subject the fabric to a washing cycle. The fabric is subjected to agitation during the washing cycle. Water is not drained off during the washing cycle but only after the whole washing cycle has finished. The washing cycle of the method of the present invention requires at least about two washing sub-cycles, although it can have more than about two. The first sub-cycle involves a first washing liquor. The first washing liquor is more concentrated than the second washing liquor. It is preferred that the duration of the first sub-cycle is longer than that of the second sub-cycle. This specific washing cycle has a number of advantages over traditional washing cycles. Herein we are talking about one washing cycle having two parts and not two different washing cycles, i.e. the washing liquor of the first sub-cycle is not emptied before the second sub-cycle. Additional water is added in the second sub-cycle to the first washing liquor to form the second washing liquor. It has now been found that the specific washing cycle of the method of the present invention, provides better cleaning and fabric maintenance than two different washing cycles, and this is even so if the two different washing cycles use more water than the washing cycle of the invention. It is also better than if a shorter washing cycles is used and the water of the second sub-cycle is used to rinse the fabric.

The first sub-cycle facilitates the deposition of the detergent onto the fabric surface. The chemical cleaning is improved due to the high concentration of the detergent as compared to a traditional washing cycle. The amount of water in the first sub-cycle is low, this greatly helps with the chemical cleaning. Preferably the volume of water in the first sub-cycle is lower than that of the second sub-cycle. Thus the function of the first sub-cycle is to contribute as much as possible to detergent deposition and chemical cleaning, in particular stain and soil removal. The second sub-cycle preferably requires a higher volume of washing liquor than the first subcycle, this contributes to separation from the fabric surface of the soil removed from the fabric, this contributes to the avoidance of dinginess and building up from the removed soil. This plays an important role in terms of fabric maintenance. The volume of water of the second sub-cycle is usually such that allows the fabric to nearly freely float, this contributes to lifting of the soil that was removed from the fabric in the first sub-cycle. The two sub-cycles of the washing cycle seem to have a synergistic rather than an additive effect on cleaning and fabric maintenance. Preferably the duration of the first sub-cycle is longer than that of the second.

This is beneficial from a catalytic chemistry view point. For example, the enzymes have more time to act. This is even more beneficial if the washing takes place at ambient temperature, under this temperature enzymes are not degraded and can keep working for the whole length of the cycle.

In a preferred embodiment the concentration, expressed in grams per litres, of the detergent in the first washing liquor is at least about 5%, more preferably at least about 10% and especially at least about 15% higher than that of the second washing liquor. This facilitates fabric deposition that is translated in better cleaning due to the high concentration of the active ingredients of the detergent composition. Preferably the concentration of the detergent in the first washing liquor is at least about 0.2, more preferably about 0.3 and especially about 0.4 g/l.

In a preferred embodiment the volume of the second washing liquor is at least about 5%, more preferably at least about 10% and especially at least about 15% higher than that of the first washing liquor. As indicated before, this high volume of water contributes to the floating of the fabric that in turn contributes to a better soil lifting that is directly translated in better cleaning.

In a preferred embodiment the volume to weight ratio of the first washing liquor to the fabric is less than about 4:1 and the ratio of the second washing liquor to the fabric is greater than about 4:1. This particular setting provides good cleaning and fabric maintenance.

In a preferred embodiment the volume of the first washing liquor is at least about 10 litres, more preferably at least about 15 litres and especially at least about 20 litres. In a preferred embodiment the volume of the second washing liquor is at least about 12 litres, more preferably at least about 18 litres and especially at least about 25 litres. In an especially preferred embodiment the volume about 5 of the first washing liquor is from about 20 to about 40 litres and the volume of the second washing liquor is from about 23 to about 50 litres, this is preferably suitable for top loader machines.

Preferably, the rinsing of the fabric involves only one rinsing step, this being specially preferred from a water saving viewpoint. In other embodiments the rinsing involves at least two different steps, this is preferred from a fabric maintenance view point.

The duration of the washing cycle can vary. Preferably the duration of the first sub-cycle is at least about 10 minutes, more preferably at least about 15 minutes and especially from about 20 to about 40 minutes. Preferably the duration of the second sub-cycle is at least about 2 minutes, more preferably at least about 7 minutes and especially from about 5 to about 15 minutes. This has proved to be optimum for cleaning and fabric maintenance while being very energy efficient. Preferably the combined time of the washing and rinse cycle is below one hour.

The method of the invention is especially suitable for use at low, i.e., ambient temperature.

Preferably the detergent composition for use herein comprise enzymes, more preferably the concentration of enzymes in the first washing liquor is from about 0.01 to about 50 ppm, more preferably from about 0.05 to about 40 ppm. Compositions comprising a plurality of enzymes have been found preferred from a performance viewpoint. Also preferred are compositions comprising a fabric shading dye. The method of the invention provide excellent results even in the absence of bleach, thus in a preferred embodiment the detergent composition comprises enzyme and is free of bleach, this allows for a better working environment for the enzymes. In a preferred embodiment the detergent composition comprises surfactant, builders and enzymes and is preferably free of bleach.

### DETAILED DESCRIPTION OF THE INVENTION

The present invention envisages a method of laundering fabric in a laundry machine. The method involves a washing cycle divided into two sub-cycles with different detergent concentration and preferably different duration. The method provides improved cleaning, fabric maintenance and it is very energy efficient. It allows for a reduced number of washing and rinsing steps thereby saving time and energy. The method is extremely suitable for washing at ambient temperature, contributing even further to energy savings.

The method of the invention requires placing the fabric in a laundry machine with a detergent composition. Water is provided into the machine to form a first washing liquor, agitation is provided. After a suitable period of time has elapsed more water is added to form a second washing liquor, then the washing liquor is drained and new water is added to rinse the fabric.

The detergent composition of the invention can be in any physical form including liquid and solid. The composition can be provided in unit dose form, preferably a water-soluble pouch having one more compartments.

Detergent Composition:

The composition typically comprises detergent ingredients. Suitable detergent ingredients include: detersive surfactants including anionic detersive surfactants, non-ionic detersive surfactants, cationic detersive surfactants, zwitterionic detersive surfactants, amphoteric detersive surfactants, and any combination thereof; polymers including carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of about 1:4:1, hexamethylenediamine derivative polymers, and any combination thereof; builders including zeolites, phosphates, citrate, and any combination thereof; buffers and alkalinity sources including carbonate salts and/or silicate salts; fillers including sulphate salts and bio-filler materials; bleach including bleach activators, sources of available oxygen, pre-formed peracids, bleach catalysts, reducing bleach, and any combination thereof; chelants; photobleach; hueing agents; brighteners; enzymes including proteases, amylases,

cellulases, lipases, xylogucanases, pectate lyases, mannanases, bleaching enzymes, cutinases, and any combination thereof; fabric softeners including clay, silicones, quaternary ammonium fabric-softening agents, and any combination thereof; flocculants such as polyethylene oxide; perfume including starch encapsulated perfume accords, perfume microcapsules, perfume loaded zeolites, schif base reaction products of ketone perfume raw materials and polyamines, blooming perfumes, and any combination thereof; aesthetics including soap rings, lamellar aesthetic particles, geltin beads, carbonate and/or sulphate salt speckles, coloured clay, and any combination thereof: and any combination thereof.

Preferred for use in the method of the invention are compositions comprising surfactants, builders, enzymes and brighteners.

Detersive Surfactant:

The composition typically comprises detersive surfactant. Suitable detersive surfactants include anionic detersive surfactants, non-ionic detersive surfactant, cationic detersive surfactants, zwitterionic detersive surfactants, amphoteric detersive surfactants, and any combination thereof. Compositions suitable for use herein comprises from about 5% to about 70% by weight, preferably from about 10% to about 60% by weight, more preferably from about 20% to about 50% by weight, of a certain kind of detersive surfactant component. Such an essential detersive surfactant component must comprise anionic surfactants, nonionic surfactants, or combinations of these two surfactant types.

Anionic Detersive Surfactant:

Suitable anionic detersive surfactants include sulphate and sulphonate detersive surfactants. Suitable sulphonate detersive surfactants include alkyl benzene sulphonate, such as C10-13 alkyl benzene sulphonate. Suitable alkyl benzene sulphonate (LAS) is obtainable, or even obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. Another suitable anionic detersive surfactant is alkyl benzene sulphonate that is obtained by DETAL catalyzed process, although other synthesis routes, such as HF, may also be suitable. Suitable sulphate detersive surfactants include alkyl sulphate, such as C8-18 alkyl sulphate, or predominantly C12 alkyl sulphate. The alkyl sulphate may be derived from natural sources, such as coco and/or tallow. Alternative, the alkyl sulphate may be derived from synthetic sources such as C12-15 alkyl sulphate.

Another suitable sulphate detersive surfactant is alkyl alkoxylated sulphate, such as alkyl ethoxylated sulphate, or a C8-18 alkyl alkoxylated sulphate, or a C8-18 alkyl ethoxylated sulphate. The alkyl alkoxylated sulphate may have an average degree of alkoxylation of from about 0.5 to about 20, or from about 0.5 to about 10. The alkyl alkoxylated sulphate may be a C8-18 alkyl ethoxylated sulphate, typically having an average degree of ethoxylation of from about 0.5 to about 10, or from about 0.5 to about 7, or from about 0.5 to about 5 or from about 0.5 to about 3.

The alkyl sulphate, alkyl alkoxylated sulphate and alkyl benzene sulphonates may be linear or branched, substituted or un-substituted. The anionic detersive surfactant may be a mid-chain branched anionic detersive surfactant, such as a mid-chain branched alkyl sulphate and/or a mid-chain branched alkyl benzene sulphonate. The mid-chain branches are typically C1-4 alkyl groups, such as methyl and/or ethyl groups.

Another suitable anionic detersive surfactant is alkyl ethoxy carboxylate. The anionic detersive surfactants are typically present in their salt form, typically being complexed with a suitable cation. Suitable counter-ions include Na+ and K+, substituted ammonium such as C1-C6 alkanolammonium such as mono-ethanolamine (MEA) tri-ethanolamine (TEA), di-ethanolamine (DEA), and any mixture thereof.

Non-Ionic Detersive Surfactant:

Suitable non-ionic detersive surfactants are selected from the group consisting of: C8-C18 alkyl ethoxylates, such as, NEODOL® non-ionic surfactants from Shell; C6-C12 alkyl phenol alkoxylates wherein optionally the alkoxylate units are ethyleneoxy units, propyleneoxy units or a mixture thereof; C12-C18 alcohol and C6-C12 alkyl phenol condensates with ethylene oxide/propylene oxide block polymers such as Pluronic® from BASF; C14-C22 mid-chain branched alcohols; C14-C22 mid-chain branched alkyl alkoxylates, typically having an average degree of alkoxylation of from about 1 to about 30; alkylpolysaccharides, such as alkylpolyglycosides; polyhydroxy fatty acid amides; ether capped poly(oxyalkylated) alcohol surfactants; and mixtures thereof.

Suitable non-ionic detersive surfactants are alkyl polyglucoside and/or an alkyl alkoxylated alcohol. Suitable non-ionic detersive surfactants include alkyl alkoxylated alcohols, such as C₈₋₁₈ alkyl alkoxylated alcohol, or a C₈₋₁₈ alkyl ethoxylated alcohol. The alkyl alkoxylated alcohol may have an average degree of alkoxylation of from about 0.5 to about 50, or from about 1 to about 30, or from about 1 to about 20, or from about 1 to about 10. The alkyl alkoxylated alcohol may be a C₈₋₁₈ alkyl ethoxylated alcohol, typically having an average degree of ethoxylation of from about 1 to about 10, or from about 1 to about 7, or from about 1 to about 5, or from about 3 to about 7. The alkyl alkoxylated alcohol can be linear or branched, and substituted or un-substituted.

Suitable nonionic detersive surfactants include secondary alcohol-based detersive surfactants having the formula:

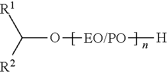

wherein R¹=linear or branched, substituted or unsubstituted, saturated or unsaturated C₂₋₈ alkyl; wherein R²=linear or branched, substituted or unsubstituted, saturated or unsaturated C₂₋₈ alkyl, wherein the total number of carbon atoms present in R¹+R² moieties is in the range of from about 7 to about 13; wherein EO/PO are alkoxy moieties selected from ethoxy, propoxy, or mixtures thereof, optionally the EO/PO alkoxyl moieties are in random or block configuration; wherein n is the average degree of alkoxylation and is in the range of from about 4 to about 10. Other suitable non-ionic detersive surfactants include EO/PO block co-polymer surfactants, such as the Plurafac® series of surfactants available from BASF, and sugar-derived surfactants such as alkyl N-methyl glucose amide.

Cationic Detersive Surfactant:

Suitable cationic detersive surfactants include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, such as chloride; sulphate; and sulphonate. Suitable cationic detersive surfactants are mono-C₆₋₁₈ alkyl monohydroxyethyl di-methyl quaternary ammonium chlorides. Suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Zwitterionic and/or Amphoteric Detersive Surfactant:

Suitable zwitterionic and/or amphoteric detersive surfactants include amine oxide such as dodecyldimethylamine N-oxide, alkanolamine sulphobetaines, coco-amidopropyl betaines, HN⁺—R—CO₂⁻ based surfactants, wherein R can be any bridging group, such as alkyl, alkoxy, aryl or amino acids.

Polymer:

Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of about 1:4:1, hexamethylenediamine derivative polymers, and any combination thereof.

Cellulosic Polymer:

The composition can comprise cellulosic polymers, such as polymers selected from alkyl cellulose, alkyl alkoxyalkyl cellulose, carboxyalkyl cellulose, alkyl carboxyalkyl, and any combination thereof. Suitable cellulosic polymers are selected from carboxymethyl cellulose, methyl cellulose, methyl hydroxyethyl cellulose, methyl carboxymethyl cellulose, and mixtures thereof. The carboxymethyl cellulose can have a degree of carboxymethyl substitution from about 0.5 to about 0.9 and a molecular weight from about 100,000 Da to about 300,000 Da. Another suitable cellulosic polymer is hydrophobically modified carboxymethyl cellulose, such as Finnfix SH-1 (CP Kelco).

Other suitable cellulosic polymers may have a degree of substitution (DS) of from about 0.01 to about 0.99 and a degree of blockiness (DB) such that either DS+DB is of at least about 1.00 or DB+2DS−DS² is at least about 1.20. The substituted cellulosic polymer can have a degree of substitution (DS) of at least about 0.55. The substituted cellulosic polymer can have a degree of blockiness (DB) of at least about 0.35. The substituted cellulosic polymer can have a DS+DB, of from about 1.05 to about 2.00. A suitable substituted cellulosic polymer is carboxymethylcellulose. Another suitable cellulosic polymer is cationically modified hydroxyethyl cellulose.

Dye Transfer Inhibitor Polymer:

Suitable dye transfer inhibitor (DTI) polymers include polyvinyl pyrrolidone (PVP), vinyl co-polymers of pyrrolidone and imidazoline (PVPVI), polyvinyl N-oxide (PVNO), and any mixture thereof.

Hexamethylenediamine Derivative Polymers:

Suitable polymers include hexamethylenediamine derivative polymers, typically having the formula:

R₂(CH₃)N⁺(CH₂)₆N⁺(CH₃)R₂.2X⁻

wherein X− is a suitable counter-ion, for example chloride, and R is a poly(ethylene glycol) chain having an average degree of ethoxylation of from about 20 to about 30. Optionally, the poly(ethylene glycol) chains may be independently capped with sulphate and/or sulphonate groups, typically with the charge being balanced by reducing the number of X− counter-ions, or (in cases where the average degree of sulphation per molecule is greater than two), introduction of Y+ counter-ions, for example sodium cations.

Builder:

Suitable builders include zeolites, phosphates, citrates, and any combination thereof.

Zeolite Builder:

The composition may be substantially free of zeolite builder. Substantially free of zeolite builder typically means comprises from about 0 wt % to about 10 wt %, zeolite builder, or to about 8 wt %, or to about 6 wt %, or to about 4 wt %, or to about 3 wt %, or to about 2 wt %, or even to about 1 wt % zeolite builder. Substantially free of zeolite builder preferably means “no deliberately added” zeolite builder. Typical zeolite builders include zeolite A, zeolite P, zeolite MAP, zeolite X and zeolite Y.

Phosphate Builder:

The composition may be substantially free of phosphate builder. Substantially free of phosphate builder typically means comprises from about 0 wt % to about 10 wt % phosphate builder, or to about 8 wt %, or to about 6 wt %, or to about 4 wt %, or to about 3 wt %, or to about 2 wt %, or even to about 1 wt % phosphate builder. Substantially free of zeolite builder preferably means “no deliberately added” phosphate builder. A typical phosphate builder is sodium tri-polyphosphate (STPP).

Citrate:

A suitable citrate is sodium citrate. However, citric acid may also be incorporated into the composition, which can form citrate in the wash liquor.

Buffer and Alkalinity Source:

Suitable buffers and alkalinity sources include carbonate salts and/or silicate salts and/or double salts such as burkeitte.

Carbonate Salt:

A suitable carbonate salt is sodium carbonate and/or sodiumbicarbonate. The composition may comprise bicarbonate salt. It may be suitable for the composition to comprise low levels of carbonate salt, for example, it may be suitable for the composition to comprise from about 0 wt % to about 10 wt % carbonate salt, or to about 8 wt %, or to about 6 wt %, or to about 4 wt %, or to about 3 wt %, or to about 2 wt %, or even to about 1 wt % carbonate salt. The composition may even be substantially free of carbonate salt; substantially free means “no deliberately added”.

The carbonate salt may have a weight average mean particle size of from about 100 to about 500 micrometers. Alternatively, the carbonate salt may have a weight average mean particle size of from about 10 to about 25 micrometers.

Silicate Salt:

The composition may comprise from about 0 wt % to about 20 wt % silicate salt, or to about 15 wt %, or to about 10 wt %, or to about 5 wt %, or about 4 wt %, or even to about 2 wt %, and may comprise from above about 0 wt %, or from about 0.5 wt %, or even from about 1 wt % silicate salt. The silicate can be crystalline or amorphous. Suitable crystalline silicates include crystalline layered silicate, such as SKS-6. Other suitable silicates include 1.6R silicate and/or 2.0R silicate. A suitable silicate salt is sodium silicate. Another suitable silicate salt is sodium metasilicate.

Filler:

The composition may comprise from about 0 wt % to about 70% filler. Suitable fillers include sulphate salts and/or bio-filler materials.

Sulphate Salt:

A suitable sulphate salt is sodium sulphate. The sulphate salt may have a weight average mean particle size of from about 100 to about 500 micrometers, alternatively, the sulphate salt may have a weight average mean particle size of from about 10 to about 45 micrometers.

Bio-Filler Material:

A suitable bio-filler material is alkali and/or bleach treated agricultural waste.

Bleach:

The composition may comprise bleach. Alternatively, the composition may be substantially free of bleach; substantially free means “no deliberately added”. Suitable bleach includes bleach activators, sources of available oxygen, pre-formed peracids, bleach catalysts, reducing bleach, and any combination thereof. If present, the bleach, or any component thereof, for example the pre-formed peracid, may be coated, such as encapsulated, or clathrated, such as with urea or cyclodextrin.

Bleach Activator:

Suitable bleach activators include: tetraacetylethylenediamine (TAED); oxybenzene sulphonates such as nonanoyloxybenzene sulphonate (NOBS), caprylamidononanoyl oxybenzene sulphonate(NACA-OBS), 3,5,5-trimethyl hex anoyloxybenzene sulphonate (Iso-NOBS), dodecyloxybenzene sulphonate (LOBS), and any mixture thereof; caprolactams; pentaacetateglucose (PAG); nitrile quaternary ammonium; imide bleach activators, such as Nnonanoyl-N-methyl acetamide; and any mixture thereof.

Source of Available Oxygen:

A suitable source of available oxygen (AvOx) is a source of hydrogen peroxide, such as percarbonate salts and/or perborate salts, such as sodium percarbonate. The source of peroxygen may be at least partially coated, or even completely coated, by a coating ingredient such as a carbonate salt, a sulphate salt, a silicate salt, borosilicate, or any mixture thereof, including mixed salts thereof. Suitable percarbonate salts can be prepared by a fluid bed process or by a crystallization process. Suitable perborate salts include sodium perborate mono15 hydrate (PB1), sodium perborate tetra-hydrate (PB4), and anhydrous sodium perborate which is also known as fizzing sodium perborate. Other suitable sources of AvOx include persulphate, such as oxone. Another suitable source of AvOx is hydrogen peroxide.

Pre-Formed Peracid:

A suitable pre-formed peracid is N,N-pthaloylamino peroxycaproic acid (PAP).

Bleach Catalyst:

Suitable bleach catalysts include oxaziridinium-based bleach catalysts, transition metal bleach catalysts and bleaching enzymes.

Chelant:

Suitable chelants are selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid), hydroxyethane di(methylene phosphonic acid), and any combination thereof. A suitable chelant is ethylene diamine-N′N′-disuccinic acid (EDDS) and/or hydroxyethane diphosphonic acid (HEDP). The laundry detergent composition may comprise ethylene diamine-N′N′-disuccinic acid or salt thereof. The ethylene diamine-N′N′-disuccinic acid may be in S,S enantiomeric form. The composition may comprise 4,5-dihydroxy-m-benzenedisulfonic acid disodium salt. Suitable chelants may also be calcium crystal growth inhibitors.

Calcium Carbonate Crystal Growth Inhibitor:

The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

Photobleach:

Suitable photobleaches are zinc and/or aluminium sulphonated phthalocyanines.

Hueing Agent:

The hueing agent (also defined herein as hueing dye) is typically formulated to deposit onto fabrics from the wash liquor so as to improve fabric whiteness perception. The hueing agent is typically blue or violet. It may be suitable that the hueing dye(s) have a peak absorption wavelength of from about 550 nm to about 650 nm, or from about 570 nm to about 630 nm. The hueing agent may be a combination of dyes which together have the visual effect on the human eye as a single dye having a peak absorption wavelength on polyester of from about 550 nm to about 650 nm, or from about 570 nm to about 630 nm. This may be provided for example by mixing a red and green-blue dye to yield a blue or violet shade.

Dyes are typically coloured organic molecules which are soluble in aqueous media that contain surfactants. Dyes maybe selected from the classes of basic, acid, hydrophobic, direct and polymeric dyes, and dye-conjugates. Suitable polymeric hueing dyes are commercially available, for example from Milliken, Spartanburg, S.C., USA.

Examples of suitable dyes are violet DD, direct violet 7, direct violet 9, direct violet 11, direct violet 26, direct violet 31, direct violet 35, direct violet 40, direct violet 41, direct violet 51, direct violet 66, direct violet 99, acid violet 50, acid blue 9, acid violet 17, acid black 1, acid red 17, acid blue 29, solvent violet 13, disperse violet 27 disperse violet 26, disperse violet 28, disperse violet 63 and disperse violet 77, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141, thiazolium dyes, reactive blue 19, reactive blue 163, reactive blue 182, reactive blue 96, Liquitint® Violet CT (Milliken, Spartanburg, USA) and Azo-CM-Cellulose (Megazyme, Bray, Republic of Ireland). Other suitable hueing agents are hueing dye-photobleach conjugates, such as the conjugate of sulphonated zinc phthalocyanine with direct violet 99. A particularly suitable hueing agent is a combination of acid red 52 and acid blue 80, or the combination of direct violet 9 and solvent violet 13.

Brightener:

Suitable brighteners are stilbenes, such as brightener 15. Other suitable brighteners are hydrophobic brighteners, and brightener 49. The brightener may be in micronized particulate form, having a weight average particle size in the range of from about 3 to about 30 micrometers, or from about 3 micrometers to about 20 micrometers, or from about 3 to about 10 micrometers. The brightener can be alpha or beta crystalline form.

Enzyme:

Suitable enzymes include proteases, amylases, cellulases, lipases, xylogucanases, pectate lyases, mannanases, bleaching enzymes, cutinases, and mixtures thereof. For the enzymes, accession numbers and IDs shown in parentheses refer to the entry numbers in the databases Genbank, EMBL and/or Swiss-Prot. For any mutations, standard 1-letter amino acid codes are used with a * representing a deletion. Accession numbers prefixed with DSM refer to micro-organisms deposited at Deutsche Sammlung von Mikroorganismen and Zellkulturen GmbH, Mascheroder Weg 1b, 38124 Brunswick (DSMZ).

If employed, enzymes will normally be incorporated into the base detergent compositions herein at levels sufficient to provide up to about 10 mg by weight, more typically from about 0.01 mg to about 5 mg, of active enzyme per gram of the composition. Stated otherwise, the aqueous detergent compositions herein can typically comprise from about 0.001% to about 5%, preferably from about 0.01% to about 1% by weight, of a commercial enzyme preparation.

Protease.

The composition may comprise a protease. Suitable proteases include metalloproteases and/or serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, Bacillus alkalophilus (P27963, ELYA_BACAO), Bacillus subtilis, Bacillus amyloliquefaciens (P00782, SUBT_BACAM), Bacillus pumilus (P07518) and Bacillus gibsonii (DSM14391).

(b) trypsin-type or chymotrypsin-type proteases, such as trypsin (e.g. of porcine or bovine origin), including the Fusarium protease and the chymotrypsin proteases derived from Cellumonas (A2RQE2).

(c) metalloproteases, including those derived from Bacillus amyloliquefaciens (P06832, NPRE_BACAM).

Suitable proteases include those derived from Bacillus gibsonii or Bacillus Lentus such as subtilisin 309 (P29600) and/or DSM 5483 (P29599).

Suitable commercially available protease enzymes include: those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase® and Purafect OXP® by Genencor International; those sold under the tradename Opticlean® and Optimase® by Solvay Enzymes; those available from Henkel/Kemira, namely BLAP (P29599 having the following mutations S99D+S101 R+S103A+V104I+G159S), and variants thereof including BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D) all from Henkel/Kemira; and KAP (Bacillus alkalophilus subtilisin with mutations A230V+S256G+S259N) from Kao.

Amylase:

Suitable amylases are alpha-amylases, including those of bacterial or fungal origin. Chemically or genetically modified mutants (variants) are included. A suitable alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, sp 707, DSM 9375, DSM 12368, DSMZ no. 12649, KSM AP1378, KSM K36 or KSM K38. Suitable amylases include:

(a) alpha-amylase derived from Bacillus licheniformis (P06278, AMY_BACLI), and variants thereof, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

(b) AA560 amylase (CBU30457, HD066534) and variants thereof, especially the variants with one or more substitutions in the following positions: 26, 30, 33, 82, 5 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, optionally that also contain the deletions of D183* and G184*.

(c) variants exhibiting at least 90% identity with the wild-type enzyme from Bacillus SP722 (CBU30453, HD066526), especially variants with deletions in the 183 and 184 positions.

Suitable commercially available alpha-amylases are Duramyl®, Liquezyme® Termamyl®, Termamyl Ultra®, Natalase®, Supramyl®, Stainzyme®, Stainzyme Plus®, Fungamyl® and BAN® (Novozymes A/S), Bioamylase® and variants thereof (Biocon India Ltd.), Kemzym® AT 9000 (Biozym Ges. m.b.H, Austria), Rapidase®, Purastar®, Optisize HT Plus®, Enzysize®, Powerase® and Purastar Oxam®, Maxamyl® (Genencor International Inc.) and KAM® (KAO, Japan). Suitable amylases are Natalase®, Stainzyme® and Stainzyme Plus®.

Cellulase:

The composition may comprise a cellulase. Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, and Carezyme® (Novozymes A/S), Clazinase®, and Puradax HA® (Genencor International Inc.), and KAC-500(B)® (Kao Corporation). The cellulase can include microbial-derived endoglucanases exhibiting endobeta-1,4-glucanase activity (E.C. 3.2.1.4), including a bacterial polypeptide endogenous to a member of the genus Bacillus sp. AA349 and mixtures thereof. Suitable endoglucanases are sold under the tradenames Celluclean® and Whitezyme® (Novozymes A/S, Bagsvaerd, Denmark).

The composition may comprise a cleaning cellulase belonging to Glycosyl Hydrolase family 45 having a molecular weight of from 17 kDa to 30 kDa, for example the endoglucanases sold under the tradename Biotouch® NCD, DCC and DCL (AB Enzymes, Darmstadt, Germany).

Suitable cellulases may also exhibit xyloglucanase activity, such as Whitezyme®.

Lipase.

The composition may comprise a lipase. Suitable lipases include those of bacterial or fungal origin. Chemically modified or protein engineered mutants are included. Examples of useful lipases include lipases from Humicola (synonym Thermomyces), e.g., from H. lanuginosa (T. lanuginosus), or from H. insolens, a Pseudomonas lipase, e.g., from P. alcaligenes or P. pseudoalcaligenes, P. cepacia, P. stutzeri, P. fluorescens, Pseudomonas sp. strain SD 705, P. wisconsinensis, a Bacillus lipase, e.g., from B. subtilis, B. stearothermophilus or B. pumilus.

The lipase may be a “first cycle lipase”, optionally a variant of the wild-type lipase from Thermomyces lanuginosus comprising T231R and N233R mutations. The wild-type sequence is the 269 amino acids (amino acids 23-291) of the Swissprot accession number Swiss-Prot 059952 (derived from Thermomyces lanuginosus (Humicola lanuginosa)). Suitable lipases would include those sold under the tradenames Lipex®, Lipolex® and Lipoclean® by Novozymes, Bagsvaerd, Denmark.

The composition may comprise a variant of Thermomyces lanuginosa (O59952) lipase having >90% identity with the wild type amino acid and comprising substitution(s) at T231 and/or N233, optionally T231R and/or N233R.

Xyloglucanase:

Suitable xyloglucanase enzymes may have enzymatic activity towards both xyloglucan and amorphous cellulose substrates. The enzyme may be a glycosyl hydrolase (GH) selected from GH families 5, 12, 44 or 74. The glycosyl hydrolase selected from GH family 44 is particularly suitable. Suitable glycosyl hydrolases from GH family 44 are the XYG1006 glycosyl hydrolase from Paenibacillus polyxyma (ATCC 832) and variants thereof.

Pectate Lyase:

Suitable pectate lyases are either wild-types or variants of Bacillus-derived pectate lyases (CAF05441, AAU25568) sold under the tradenames Pectawash®, Pectaway® and X-Pect® (from Novozymes A/S, Bagsvaerd, Denmark).

Mannanase:

Suitable mannanases are sold under the tradenames Mannaway® (from Novozymes A/S, Bagsvaerd, Denmark), and Purabrite® (Genencor International Inc., Palo Alto, Calif.).

Bleaching Enzyme:

Suitable bleach enzymes include oxidoreductases, for example oxidases such as glucose, choline or carbohydrate oxidases, oxygenases, catalases, peroxidases, like halo-, chloro-, bromo-, lignin-, glucose- or manganeseperoxidases, dioxygenases or laccases (phenoloxidases, polyphenoloxidases). Suitable commercial products are sold under the Guardzyme® and Denilite® ranges from Novozymes. It may be advantageous for additional organic compounds, especially aromatic compounds, to be incorporated with the bleaching enzyme; these compounds interact with the bleaching enzyme to enhance the activity of the oxidoreductase (enhancer) or to facilitate the electron flow (mediator) between the oxidizing enzyme and the stain typically over strongly different redox potentials.

Other suitable bleaching enzymes include perhydrolases, which catalyse the formation of peracids from an ester substrate and peroxygen source. Suitable perhydrolases include variants of the Mycobacterium smegmatis perhydrolase, variants of so-called CE-7 perhydrolases, and variants of wild-type subtilisin Carlsberg possessing perhydrolase activity.

Cutinase:

Suitable cutinases are defined by E.C. Class 3.1.1.73, optionally displaying at least 90%, or 95%, or most optionally at least 98% identity with a wildtype derived from one of Fusarium solani, Pseudomonas Mendocina or Humicola Insolens.

Identity.

The relativity between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

Fabric-Softener:

Suitable fabric-softening agents include clay, silicone and/or quaternary ammonium compounds. Suitable clays include montmorillonite clay, hectorite clay and/or laponite clay. A suitable clay is montmorillonite clay. Suitable silicones include amino-silicones and/or polydimethylsiloxane (PDMS). A suitable fabric softener is a particle comprising clay and silicone, such as a particle comprising montmorillonite clay and PDMS.

Flocculant:

Suitable flocculants include polyethylene oxide; for example having an average molecular weight of from 300,000 Da to 900,000 Da.

Suds Suppressor:

Suitable suds suppressors include silicone and/or fatty acid such as stearic acid.

Perfume:

Suitable perfumes include perfume microcapsules, polymer assisted perfume delivery systems including Schiff base perfume/polymer complexes, starchencapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC).

Aesthetic:

Suitable aesthetic particles include soap rings, lamellar aesthetic particles, geltin beads, carbonate and/or sulphate salt speckles, coloured clay particles, and any combination thereof.

Method of Laundering Fabric:

The method of laundering fabric typically comprises the step of contacting the detergent composition to water to form a wash liquor, and laundering fabric in said wash liquor, wherein typically the wash liquor has a temperature of above about 0° C. to about 90° C., or to about 60° C., or to about 40° C., or to about 30° C., or to about 20° C., or to about 10° C., or even to about 8° C. Preferably the method of the invention takes place at ambient temperature. The fabric may be contacted to the water prior to, or after, or simultaneous with, contacting the laundry detergent composition with water.

Typically, the wash liquor is formed by contacting the laundry detergent to water in such an amount so that the concentration of laundry detergent composition in the wash liquor is from above about 0 g/1 to about 5 g/l, or from about 1 g/l, and to about 4.5 g/l, or to about 4.0 g/l, or to about 3.5 g/l, or to about 3.0 g/l, or to about 2.5 g/l, or even to about 2.0 g/l, or even to about 1.5 g/l. The method of laundering fabric may be carried out in a top-loading or frontloading automatic washing machine. In these applications, the wash liquor formed and concentration of laundry detergent composition in the wash liquor is that of the corresponding washing cycle. Any input of water during any optional rinsing step(s) is not included when determining the volume of the washing liquor.

The wash liquor may comprise about 60 litres or less of water, or about 50 litres or less, or about 40 litres or less, or about 30 litres or less, or about 20 litres or less, or about 10 litres or less, or about 8 litres or less, about 5 or even about 6 litres or less of water. The wash liquor may comprise from above about 0 to about 15 litres, or from about 2 litres, and to about 12 litres, or even to about 8 litres of water.

Typically from about 0.01 kg to about 2 kg of fabric per litre of wash liquor is dosed into said wash liquor. Typically from about 0.01 kg, or from about 0.05 kg, or from about 0.07 kg, or from about 0.10 kg, or from about 0.15 kg, or from about 0.20 kg, or from about 0.25 kg fabric per litre of wash liquor is dosed into said wash liquor.

Optionally, about 60 g or less, or about 50 g or less, or about 40 g or less, or about 35 g or less, or about 30 g or less, or about 25 g or less of the composition is contacted to water to form the wash liquor.

### Examples of Typical Detergent Compositions

| Ingredient | Amount (in wt %) |
|---|---|
| Anionic detersive surfactant (such as alkyl benzene | from about 8 wt % |
| sulphonate, alkyl ethoxylated sulphate and mixtures | to about 25 wt % |
| thereof) | |
| Non-ionic detersive surfactant (such as alkyl | from about 0.0 wt % |
| ethoxylated alcohol) | to about 4 wt % |
| Cationic detersive surfactant (such as quaternary | from about 0 to |
| ammonium compounds) | about 4 wt % |
| Other detersive surfactant (such as zwiterionic | from about 0 wt % |
| detersive surfactants, amphoteric surfactants and | to about 4 wt % |
| mixtures thereof) | |
| Carboxylate polymer (such as co-polymers of maleic | from about 0 wt % |
| acid and acrylic acid) | to about 4 wt % |
| Polyethylene glycol polymer (such as a polyethylene | from about 0 wt % |
| glycol polymer comprising poly vinyl acetate side | to about 4 wt % |
| chains) | |
| Polyester soil release polymer (such as Repel-o-tex | from about 0 to |
| and/or Texcare polymers) | about 2 wt % |
| Cellulosic polymer (such as carboxymethyl | from about 0 wt % |
| cellulose, methyl cellulose and combinations | to about 2 wt % |
| thereof) | |
| Other polymer (such as amine polymers, dye | from about 0 wt % |
| transfer inhibitor polymers, hexamethylenediamine | to about 4 wt % |
| derivative polymers, and mixtures thereof) | |
| Zeolite builder and phosphate builder (such as | from about 0 wt % |
| zeolite 4A and/or sodium tripolyphosphate) | to about 15 wt % |
| Other builder (such as sodium citrate and/or | from about 0 wt % |
| citric acid) | to about 15 wt % |
| Carbonate salt (such as sodium carbonate and/or | from about 5 wt % |
| sodium bicarbonate) | to about 30 wt % |
| Silicate salt (such as sodium silicate) | from about 0 wt % |
| | to about 10 wt % |
| Source of available oxygen (such as sodium | from about 0 wt % |
| percarbonate) | to about 25 wt % |
| Bleach activator (such as tetraacetylethylene | from about 0 wt % |
| diamine (TAED) and/or nonanoyloxybenzene- | to about 8 wt % |
| sulphonate (NOBS) | |
| Bleach catalyst (such as oxaziridinium-based bleach | from about 0 wt % |
| catalyst and/or transition metal bleach catalyst) | to about 0.1 wt % |
| Other bleach (such as reducing bleach and/or | from about 0 wt % |
| pre-formed peracid) | to about 10 wt % |
| Chelant (such as ethylenediamine-N′N′-disuccinic | from about 0 wt % |
| acid (EDDS) and/or hydroxyethane diphosphonic | to about 1 wt % |
| acid (HEDP) | |
| Photobleach (such as zinc and/or aluminium | from about 0 wt % |
| sulphonated phthalocyanine) | to about 0.1 wt % |
| Hueing agent (such as direct violet 99, acid red 52, | from about 0 wt % |
| acid blue 80, direct violet 9, solvent violet 13 and | to about 1 wt % |
| any combination thereof) | |
| Brightener (such as brightener 15 and/or | from about 0 wt % |
| brightener 49) | to about 0.4 wt % |
| Protease (such as Savinase, Savinase Ultra, Purafect, | from about 0 |
| FN3, FN4 and any combination thereof) | mg/100 g to about |
| | 10 mg/100 g |
| Amylase (such as Termamyl, Termamyl ultra, | from about 0 |
| Natalase, Optisize, Stainzyme, Stainzyme Plus and | mg/100 g to about |
| any combination thereof) | 10 mg/100 g |
| Cellulase (such as Carezyme and/or Celluclean) | from about 0 |
| | mg/100 g to about |
| | 10 mg/100 g |
| Lipase (such as Lipex, Lipolex, Lipoclean and any | from about 0 |
| combination thereof) | mg/100 g to about |
| | 10 mg/100 g |
| Other enzyme (such as xyloglucanase, cutinase, | from about 0 |
| pectate lyase, mannanase, bleaching enzyme) | mg/100 g to about |
| | 10 mg/100 g |
| Fabric softener (such as montmorillonite clay | from about 0 wt % |
| and/or polydimethylsiloxane (PDMS) | to about 4 wt % |
| Flocculant (such as polyethylene oxide) | from about 0 wt % |
| | to about 1 wt % |
| Suds suppressor (such as silicone and/or fatty acid) | from about 0 wt % |
| | to about 0.1 wt % |
| Perfume (such as perfume microcapsule, spray-on | from about 0.1 wt % |
| perfume, starch encapsulated perfume accords, | to about 2 wt % |
| perfume loaded zeolite, and any combination | |
| thereof) | |
| Aesthetics (such as coloured soap rings and/or | from about 0 wt % |
| coloured speckles/noodles) | to about 4 wt % |
| Miscellaneous | Balance |

### Example

A top load automatic washing machine is loaded with 2 kg of fabric and 50 g of a detergent composition as detailed in the table below. The machine draws in sufficient water (25 litre) to dissolve the detergent and completely wet the load. The load is agitated for 30 minutes then additional water (5 litres) is added to allow the fabric to float and move more freely. Agitation continues (10 min)

The machine drains the water and spins the load to remove excess water. The machine re-fills to the higher water level (30 litres) and performs a single rinsing phase (10 minutes). The machine drains and spins the load

| Ingredient | Amount (in wt %) | |
|---|---|---|
| Anionic detersive surfactant (such as alkyl benzene | 15.5 | wt % |
| sulphonate, alkyl ethoxylated sulphate and mixtures | | |
| thereof) | | |
| Cellulosic polymer (such as carboxymethyl cellulose, | 0.15 | wt % |
| methyl cellulose and combinations thereof) | | |
| Zeolite builder and phosphate builder (such as zeolite | 5 | wt % |
| 4A and/or sodium tripolyphosphate) | | |
| Other builder (such as sodium citrate and/or citric acid) | 4 | wt % |
| Carbonate salt (such as sodium carbonate and/or | 28 | wt % |
| sodium bicarbonate) | | |
| Brightener (such as brightener 15 and/or brightener 49) | 0.25 | wt % |
| Protease (such as Savinase, Savinase Ultra, Purafect, | 1.64 mg/100 g | |
| FN3, FN4 and any combination thereof) | | |
| Lipase (such as Lipex, Lipolex, Lipoclean and any | 0.3 mg/100 g | |
| combination thereof) | | |
| Perfume (such as perfume microcapsule, spray-on | 0.2 | wt % |
| perfume, starch encapsulated perfume accords, | | |
| perfume loaded zeolite, and any combination thereof) | | |
| Aesthetics (such as coloured soap rings and/or | 1.0 | wt % |
| coloured speckles/noodles) | | |

| | |
|---|---|
| Miscellaneous | balance |

The dimensions and values disclosed herein are not to be understood as being strictly limited to the exact numerical values recited. Instead, unless otherwise specified, each such dimension is intended to mean both the recited value and a 5 functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering fabric in a laundry machine, comprising the steps of:
a. placing the fabric into a laundry machine and adding a detergent composition;
b. subjecting the fabric to a two-parts washing cycle having a first and a second consecutive sub-cycles, the first sub-cycle having a first washing liquor and the second sub-cycle having a second washing liquor wherein the first washing liquor is more concentrated than the second washing liquor and preferably wherein the duration of the first washing sub-cycle is longer than the duration of the second washing sub-cycle; and
c. rinsing the fabric.

2. A method according to claim 1 wherein the detergent concentration of the first washing liquor is at least about 5% higher than that of the second washing liquor.

3. A method according to claim 1 wherein the volume of the second washing liquor is at least about 5% higher than that of the first washing liquor.

4. A method according to claim 1 wherein the duration of the first washing sub-cycle is at least about 5% longer than the duration of the second washing sub-cycle.

5. A method according to claim 1 wherein the volume to weight ratio of the first washing liquor to the fabrics is less than about 4:1 and the ratio of the second washing liquor to the fabrics is greater than about 4:1.

6. A method according to claim 1 wherein the rinsing of the A method according to claim 1 wherein fabric involves only one rinsing step.

7. A method according to claim 1 wherein the duration of the first washing sub-cycle is at least about 10 minutes.

8. A method according to claim 1 wherein the combined duration of the washing and the rinsing cycles is below about an hour.

9. A method according to claim 1 wherein the temperature of the washing and the rinsing liquor is about ambient temperature.

10. A method according to claim 1 wherein the laundry machine is a top loader.

11. A method according to claim 10 wherein the volume of the washing liquor of the first cycle is less than about 40 litres.

12. A method according to claim 11 wherein the volume of the washing liquor of the second cycle is less than about 50 litres.

13. A method according to claim 1 wherein the detergent composition comprises enzymes.

14. A method according to claim 13 wherein the concentration of enzymes in the first washing liquor is from about 0.01 to about 50 ppm.

15. A method according to claim 13 wherein the enzymes are selected from the group consisting of amylases, arabinosidases, carbohydrases, cellulases, chondroitinases, cutinases, dextranases, esterases, β-glucanases, gluco-amylases, hyaluronidases, keratanases, laccases, ligninases, lipasess lipoxygenases, malanases, mannanases, oxidases, pectinases, pentosanases, peroxidases, phenoloxidases, phospholipases, proteases, pullulanases, reductases, tannases, transferases, xylanases, xyloglucanases and mixtures thereof.

16. A method according to claim 13 wherein the composition comprises greater than four unique enzyme classes according to E.C classification.

17. A method according to claim 1 wherein the detergent composition comprises a fabric shading dye.
